(19) United States
(12) Patent Application Publication
(10) Pub. No.: US 2014/0211394 A1
(43) Pub. Date: Jul. 31, 2014

(54) ELECTRONIC DEVICE WITH DETACHABLE KEYBOARD

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); YI-RU LAI, New Taipei (TW)

(73) Assignee: HON HAI PRECISION INDUSTRY CO., LTD., New Taipei (TW)

(21) Appl. No.: 14/156,499

(22) Filed: Jan. 16, 2014

(30) Foreign Application Priority Data
Jan. 29, 2013 (TW) 102103265

(51) Int. Cl. G06F 1/16

(52) U.S. Cl. CPC G06F 1/1669
USPC 361/679.17

(57) ABSTRACT

An electronic device includes a base, a cover, and a keyboard module. The base includes a mounting end and a first supporting end. The cover includes a connecting end and a second supporting end. The connecting end is pivotally mounted on the mounting end of the base. A bottom portion of the keyboard module includes a screen. The keyboard module is detachably mounted on the base to expose the screen. The cover rotates relative to the base to have the first supporting end and the second supporting end supporting the cover and the base to use the screen.

### BACKGROUND

1. Technical Field

The disclosure generally relates to electronic devices, and more particularly to an electronic device which has a detachable keyboard.

2. Description of Related Art

Electronic devices, such as notebook computers, are widely used. The notebook computers are often equipped with keyboards for inputting information. The keyboard is secured and integrated onto the notebook computer. When the keyboard needs to be replaced, it is often inconvenient to detach the integrated keyboard from the notebook computer.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device with a detachable keyboard module.

FIG. 2 is similar to FIG. 1, with the keyboard module viewed from another aspect.

FIG. 3 is a block diagram of a key unit of the electronic device of FIG. 1.

FIG. 4 is an assembled view of the electronic device of FIG. 1, which shows the electronic device is in a first state.

FIG. 5 is another assembled view of the electronic device of FIG. 4, which shows the electronic device is in a second state.

FIG. 6 is a side view of the electronic device of FIG. 5.

FIG. 7 is another assembled view of the electronic device of FIG. 4, which shows the electronic device is in a third state.

FIG. 8 is an isometric view of a keyboard module of the electronic device of FIG. 1 and an all-in-one computer.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

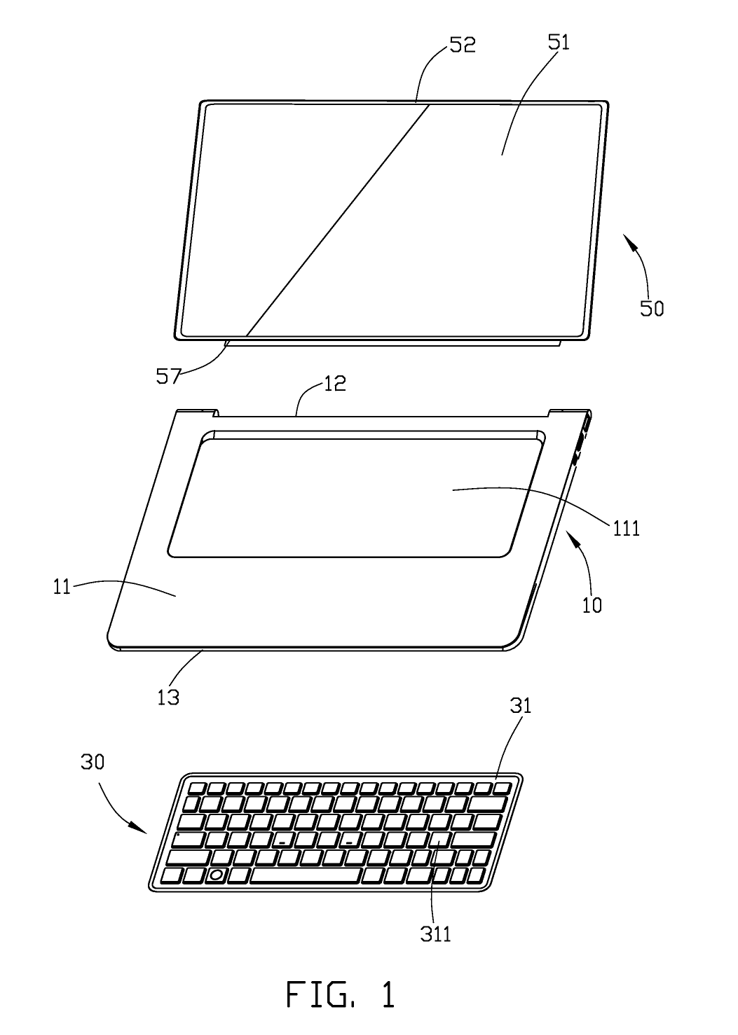

FIG. 1 shows one embodiment of an electronic device. The electronic device includes a base 10, a keyboard module 30, and a cover 50. The cover 50 can be pivotally mounted on the base 10. The keyboard module 30 can be mounted in the base 10.

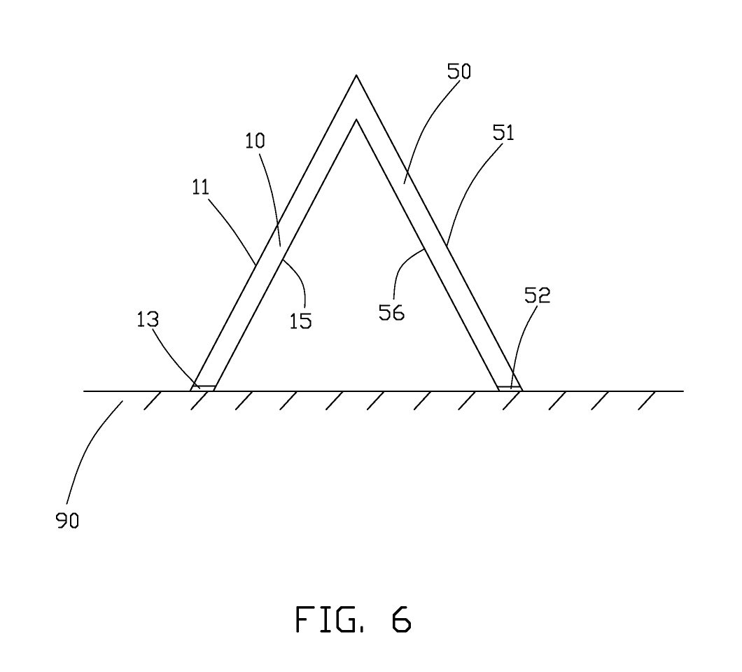

FIGS. 1 and 6 show that the base 10 includes a working surface 11 and a placing surface 15 opposite to the working surface 11. The placing surface 15 can be substantially parallel to the working surface 11. A first supporting end 13 is connected between rear edges of the working surface 11 and the placing surface 15. A connecting end 12 is connected between front edges of the working surface 11 and the placing surface 15. The rear edge of the working surface 11 can be misaligned with the rear edge of the placing surface 15 so that the first supporting end 13 is sloped. Alternatively, the first supporting end 13 can be rounded or any other shape. An acute angle is defined between the working surface 11 and the first supporting end 13. An obtuse angle is defined between the placing surface 15 and the first supporting end 13.

The working surface 11 defines a receiving space 111 adjacent to the mounting end 12. A shape and a size of the receiving space 111 are similar to those of the keyboard module 30, so that the the keyboard module 30 can be received in the receiving space 111. A depth of the receiving space 111 can be substantially equal to a thickness of the keyboard module 30.

One side of cover 50 includes a display apparatus 51 and another side of the cover 50 includes a cover plate 56 opposite to and substantially parallel to the display apparatus 51. The cover 50 can rotate on the base 10 between 0 degrees and 360 degrees. A second supporting end 52 is connected between front edges of the display apparatus 51 and the cover plate 56. A connecting end 57 is connected between rear edges of the display apparatus 51 and the cover plate 56. The front edge of the display apparatus 51 can be misaligned with the front edge of the cover plate 56 so that, the second supporting end 52 is sloped. Alternatively, the second supporting end 52 can be rounded or any other shape. An acute angle is defined between the display apparatus 51 and the second supporting end 52. An obtuse angle is defined between the cover plate 56 and the second supporting end 52.

The first supporting end 13 and the second supporting end 52 can be made of material which has a large friction factor to support the electronic device.

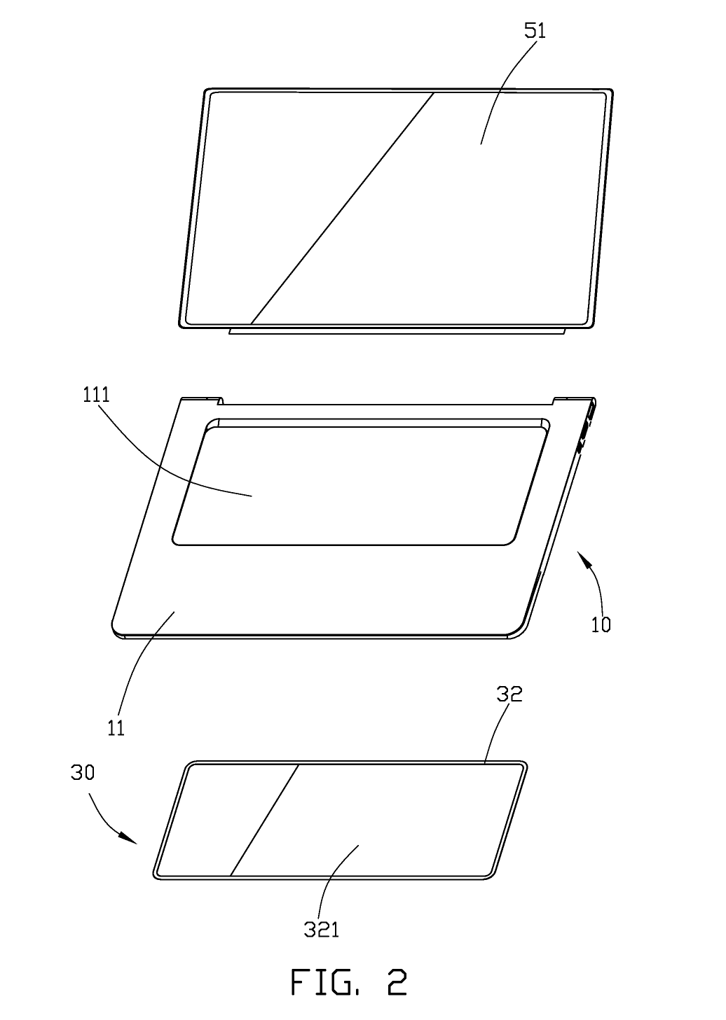

FIGS. 1 and 2 show the keyboard 30 is a rectangular block, including a first side 31 and a second side 32 opposite to the first side 31. The first side 31 is substantially parallel to the second side 32. The first side 31 includes a key unit 31 which includes a plurality of keys. The second side 32 includes a screen 321. In one embodiment, the screen 321 is a touch screen.

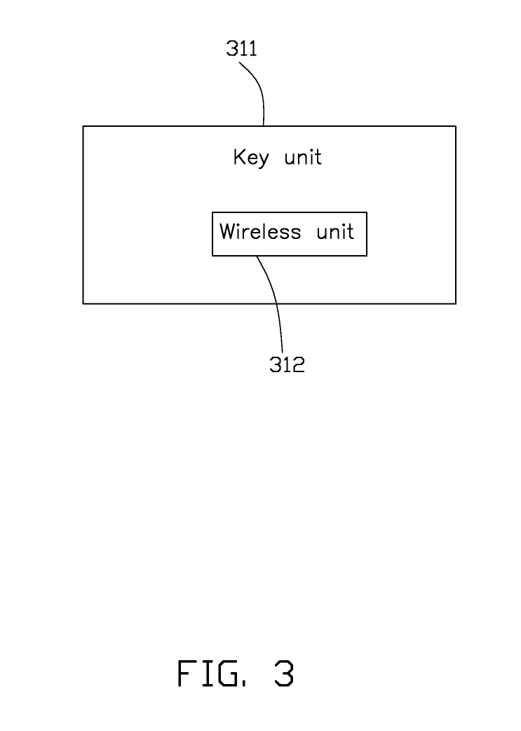

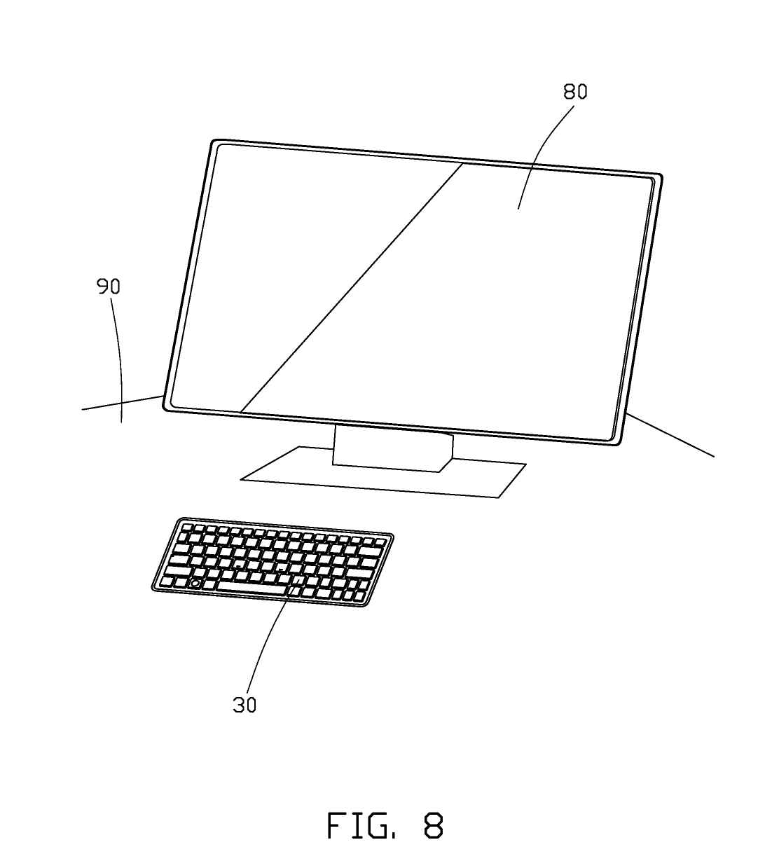

FIG. 3 shows the key unit 31 is a wireless keyboard including a wireless unit 312. The wireless unit 312 can be a BLUETOOTH unit, a WIFI unit, or an infrared unit. The key unit 31 is connected to the electronic device or an all-in one computer (as shown in FIG. 8) via the wireless unit 312.

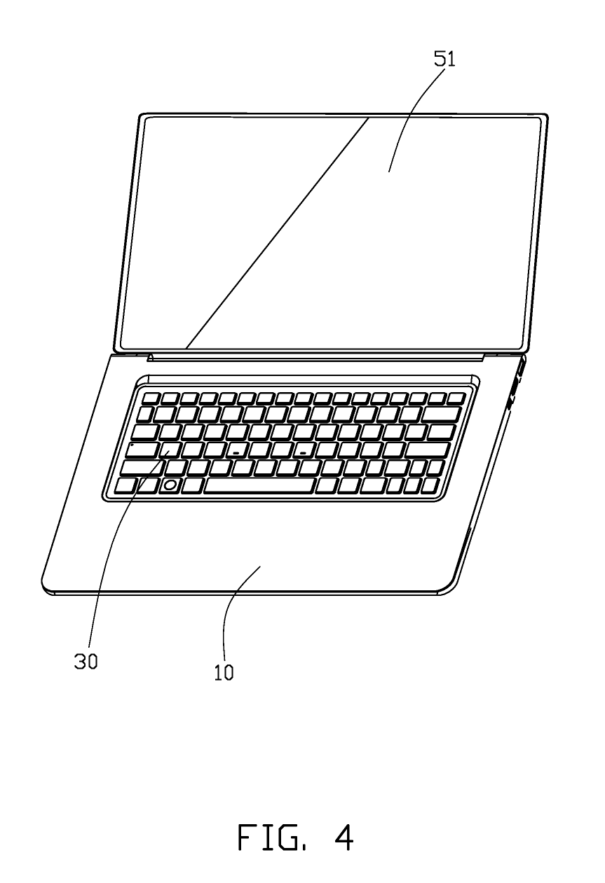

FIGS. 1 and 4 show that the electronic device is being used in a first manner. The first side 31 of the keyboard module 30 is located above the second side 32. The keyboard module 30 is moved in the receiving space 111 of the base 10. The key unit 311 is exposed on the working surface 11. The keys of the key unit 311 can be pressed to input information. The placing surface 15 is placed on a desk. The cover 50 rotates relative to the base 10 to define an angle between the working surface 11 and the display apparatus 51 less than 180 degrees.

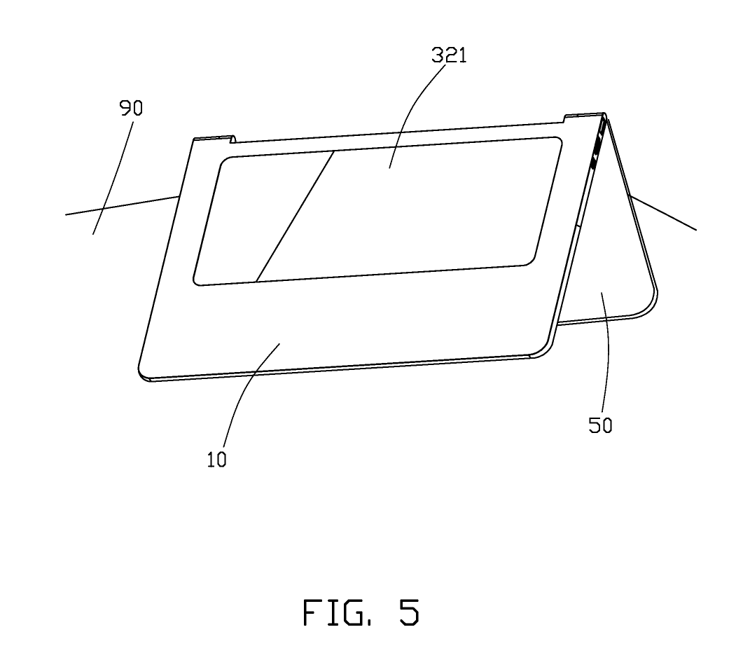

FIGS. 2, 5, and 6 show that the electronic device is being used in a second manner. The second side 32 of the keyboard module 30 is located above the first side 31. The keyboard module 30 is moved in the receiving space 111 of the base 10. The screen 321 is exposed on the working surface 11. The cover 50 rotates relative to the base 10 to define the angle between the working surface 11 and the display apparatus 51 greater than 180 degrees. The first supporting end 13 and the second supporting end 52 are placed on an operating bench. Thereby, the screen 321 and the display apparatus 51 face opposite directions. Different users, who are sitting face to face, can respectively watch the screen 321 and the display apparatus 51 simultaneously. If the screen 321 is a touch screen, users can input information on the screen 321.

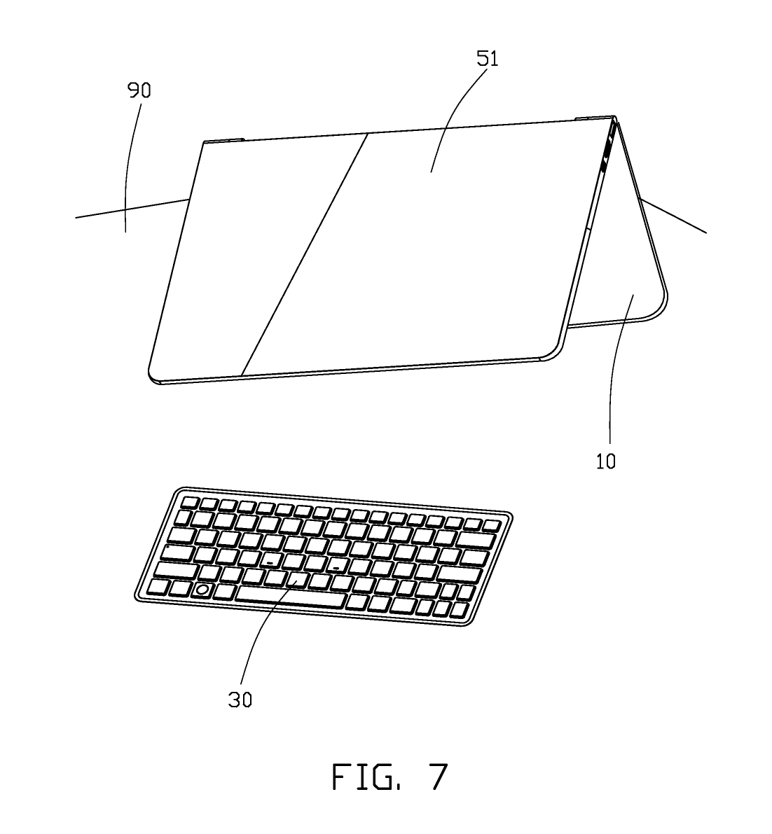

FIG. 7 shows the keyboard module 30 can be detached from the base 10 and placed in front of the display apparatus 51. The keyboard module 30 can communicate with the electronic device via the wireless unit 312 to input information on the display apparatus 51.

FIG. 8 shows the keyboard module 30 can be placed on a front portion of an all-in-one computer 80 after the keyboard module 30 is detached from the base 10. The keyboard module 30 can communicate with the all-in-one computer 80 via the wireless unit 312 to input information on the all-in-one computer 80.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base comprising a mounting end and a first supporting end;
a cover comprising a second supporting end and a connecting end pivotally mounted on the mounting end of the base; and
a keyboard module, wherein a bottom portion of the keyboard module comprises a screen, the keyboard module is detachably mounted on the base to expose the screen, and the cover is configured to rotate relative to the base with the first supporting end and the second supporting end respectively supporting the cover and the base.

2. The electronic device of claim 1, wherein the base comprises a working surface and a placing surface opposite to the working surface, the first supporting end is connected between rear edges of the working surface and the placing surface, the cover comprises a display apparatus and a cover plate opposite to the display apparatus, and the second supporting end is connected between front edges of the display apparatus and the cover plate.

3. The electronic device of claim 2, wherein the placing surface is substantially parallel to the working surface, the rear edge of the working surface is misaligned to the rear edge of the placing surface, and the first supporting end is sloped.

4. The electronic device of claim 3, wherein an acute angle is defined between the working surface and the first supporting end, and an obtuse angle is defined between the placing surface and the first supporting end.

5. The electronic device of claim 3, wherein the base defines a receiving space, and the keyboard module is received in the receiving space.

6. The electronic device of claim 1, wherein the first supporting end and the second supporting end are rough to support the cover and the base.

7. The electronic device of claim 1, wherein the keyboard module comprises a wireless unit, and the keyboard module communicates with the base via the wireless unit.

8. The electronic device of claim 1, wherein the keyboard module comprises a wireless unit, and the keyboard module is configured to communicate with a computer via the wireless unit after the keyboard module is detached from base.

9. The electronic device of claim 1, wherein the screen is a touch screen.

10. An electronic device, comprising:
a base comprising a working surface;
a keyboard module detachably mounted in the working surface, a top of the keyboard comprising a key unit, and a bottom of the keyboard module comprising a touch screen; and
a cover pivotally mounted on the base, one side of the cover comprising a display apparatus;
wherein the keyboard module is configured to be mounted on the base in different directions to either expose the key unit or the touch screen, the key unit is configured to be used to input information to the display apparatus when an angle between the working surface and the display apparatus is smaller than 180 degrees and the key unit is exposed on the base; the touch screen is configured to be used to input information to the display apparatus when the angle between the working surface and the display apparatus is smaller than 180 degrees and the touch screen is exposed on the base; and the touch screen and the display apparatus are configured to face opposite directions when the angle between the working surface and the display apparatus is larger than 180 degrees and the touch screen is exposed on the base.

11. The electronic device of claim 10, wherein the base comprises a first supporting end, the cover comprises a second supporting end, the first supporting end and the second supporting end cooperatively support the base and the cover with the touch screen and the display apparatus facing opposite directions.

12. The electronic device of claim 11, wherein the base comprises a placing surface opposite to the working surface, the first supporting end is connected between rear edges of the working surface and the placing surface, the cover comprises a cover plate opposite to the display apparatus, and the second supporting end is connected between front edges of the display apparatus and the cover plate.

13. The electronic device of claim 12, wherein the rear edge of the working surface is misaligned to the rear edge of the placing surface, and the first supporting end is sloped; the front edge of the display apparatus is misaligned to the front edge of the cover plate, and the second supporting end is sloped.

14. The electronic device of claim 13, wherein an acute angle is defined between the working surface and the first supporting end, and an obtuse angle is defined between the placing surface and the first supporting end; an acute angle is defined between the display apparatus and the second supporting end, and an obtuse angle is defined between the cover plate and the second supporting end.

15. The electronic device of claim 10, wherein the first supporting end and the second supporting end are rough to support the cover and the base.

16. The electronic device of claim 10, wherein the keyboard module includes a wireless unit, and the keyboard module communicates with the base via the wireless unit.

17. The electronic device of claim 10, wherein the keyboard module includes a wireless unit, and the keyboard module is configured to communicate with an computer via the wireless unit after the keyboard module is detached from base.
